(19) United States
(12) Patent Application Publication
(10) Pub. No.: US 2021/0258454 A1
(43) Pub. Date: Aug. 19, 2021

(54) WEARABLE CAMERA DEVICE

(71) Applicant: LINKFLOW CO., LTD, Seoul (KR)

(72) Inventors: Hong Kyu JIN, Gyeonggi-do (KR); Ji Ha HWANG, Seoul (KR)

(21) Appl. No.: 17/250,211

(22) PCT Filed: Aug. 2, 2019
(86) PCT No.: PCT/KR2019/009695

§ 371 Date: Dec. 15, 2020

(30) Foreign Application Priority Data
Feb. 22, 2019 (KR) 10-2019-0021459

(51) Int. Cl. H04N 5/225; H04N 5/232; G06F 1/16

(52) U.S. Cl. CPC H04N 5/2252; G06F 1/163; H04N 5/23219; H04N 5/2257

(57) ABSTRACT

A wearable camera device attachable and detachable to a user's neck includes a central frame. First and second frames are respectively coupled to both sides of the central frame to form a loop-shaped frame part with the central frame. One or more camera modules are provided in the frame part, wherein the first and second frames are outwardly spread and thus the central frame made of an resilient material is resiliently deformed and an open portion at one end of the frame part is generated or expanded to secure a space for wearing the wearable camera device.

### TECHNICAL FIELD

The present disclosure relates to a wearable device, and more specifically, to a wearable camera device easily worn on a user's neck and capable of capturing images at various angles simultaneously with enhanced user convenience and safety.

### BACKGROUND ART

Various wearable devices have been developed and are on the market, and among them, a wearable camera device which is mounted on a user's body to capture the surrounding environment while allowing the user to freely use both hands can be used for various purposes. Specifically, a wearable camera device can be used to capture an immersive video which makes users feel like they are at the scene, or can be used by a police officer or safety officer dispatched to an emergency scene to capture the situation on scene. However, a conventional wearable camera can capture only images in a specific direction and thus images from multiple angles cannot be obtained or there is a limitation that image resolution is low.

Meanwhile, a 360-degree camera device in the form of a neck band which can be worn on and taken off a user's neck as needed has an advantage in that a user's freedom of activity is high without obstructing the user's field of view, and it is possible to secure an immediate shoot position. However, in order to capture a 360-degree image in high resolution, a plurality of high-resolution cameras should be mounted on a loop-shaped frame, and in this case, various problems can occur.

First, relative positions between a plurality of cameras, spaced apart from each other, mounted on a loop-shaped frame should be maintained stably and firmly. Flexibility of the frame should be secured so that the shape of the frame can be deformed in order to be easily mounted around the neck. That is, the frame on which the cameras are mounted should have conflicting structural characteristics of a certain degree of rigidity and at the same time easy resilient deformation for attachment and detachment to user's body with securing a product lifespan. However, it is not easy to simultaneously solve the requirement for above contradicting structural characteristics.

Second, for long-term use, a power supply line which supplies electric power to the high-resolution camera from a separate large-capacity battery pack should be accommodated in the frame. However, in order to wear a wearable camera device, the frame should be resiliently deformed, and when this deformation is repeated, damage due to friction, bending, or the like can occur in the power supply line (cable) portion accommodated in the area where the deformation is locally concentrated.

Third, when user wears on a wearable camera for a long time at a scene, heat generated by a high-resolution camera which comes into contact with or is located adjacent to the user's neck can cause low-temperature burns. According to the internationally accepted safety standard EN563, a burn surface temperature limit of plastic is specified to be 60 degree within 1 minute, 48 degrees within 10 minutes, and 43 degrees within 8 hours, but in the case of a conventional wearable camera device, there was no awareness of this problem.

### SUMMARY OF THE INVENTION

### Technical Problem

The present disclosure is directed to providing a wearable camera which is easily wearable on a user's neck and stably holds a plurality of cameras when worn and thus has excellent image quality.

The present disclosure is directed to providing a wearable camera device in which the power supply line for power supply from a large-capacity battery can be easily assembled, and damage of the power supply line due to friction or bending can be prevented even after repeated use.

The present disclosure is directed to providing a wearable camera device capable of preventing low temperature burns even in the case of high-resolution image capturing for a long time in a state of being worn on the body.

The present disclosure is directed to providing a high-resolution wearable camera device in which flexibility is enhanced and an resiliently deformed portion is disposed to be symmetrically separated, and thus a lifespan of a product is long and user convenience and assembly are excellent.

According to another embodiment, the present disclosure is directed to providing a hook fastening structure of a band fixing part which is easily assembled but not separated.

### Technical Solution

According to an aspect of the present disclosure, there is provided a wearable camera device attachable and detachable to a user's neck, the wearable camera device including: a central frame; first and second frames respectively coupled to both sides of the central frame to form a loop-shaped frame part with the central frame; and one or more camera modules provided in the frame part, wherein the first and second frames are outwardly spread and thus the central frame made of an resilient material is resiliently deformed and an open portion at one end of the frame part is generated or expanded to secure a space for wearing the wearable camera device.

A hollow cavity may be formed in the central frame, and the frame part may be an open loop of which one region is open or a closed loop. When the first and second frames extend to vertically overlap each other or to be vertically fastened to each other, the frame part may be substantially an open loop but may have a closed loop shape, and in the case of a structure in which the first and second frames are coupled to each other, the frame part may be a closed loop but the first and second frames may be detachably coupled to each other by a magnet or another simple device to easily open a fastening part for wearing.

The central frame may be formed in a T-shape, the hollow cavity may have three end portions of both side surfaces and a lower portion which are open, and the lower portion of the central frame may be connected to a battery connection tube. A plurality of power supply lines accommodated in the battery connection tube may be branched to both sides in the hollow cavity of the central frame to be guided to both side surfaces of the T-shape.

A separation wall may be formed in the center portion of the hollow cavity, and a lower portion of the separation wall may be opened so that a connection tube coupling hole of the battery connection tube coupled to the lower portion of the central frame may communicate with the cavities on both sides of the separation wall.

According to another embodiment of the present disclosure, a hollow cavity may be formed in the central frame, a separation wall may be formed in the center portion of the hollow cavity, and the cavities may be formed to be symmetrical with respect to the separation wall.

Each of the one or more camera modules may be accommodated in a camera holder, and the camera holder may include a cover portion formed of a rubber material integrally formed on an outer surface of a base portion formed of plastic.

According to one embodiment of the present disclosure, each of the one or more camera modules may be accommodated in the camera holder, and the camera holder may include an upper cover and a lower cover coupled to the upper cover. The upper cover may be disposed in an imaging direction of the camera module, may be formed with an opening in an upper surface thereof, and may cover an upper portion of the camera module, and the lower cover may be disposed under the camera module and may be adjacent to the user's body when wearing by the user. The lower cover may include a cover portion coupled to the base portion, and the base portion formed of plastic and the cover portion formed of a thermoplastic elastomer (TPE) may be integrally molded by double injection.

An upper end of the cover portion may be formed to protrude more than an upper end of the base portion, and thus the upper end of the base portion and the upper end of the cover portion may form a step. A round portion may be formed on an upper inner circumferential surface of the cover portion, and an outer circumferential edge of a lower end portion of the upper cover may come into close contact with the round portion while pressurizing the round portion.

According to another aspect of the present disclosure, there is provided a wearable device which can be worn on the user's body, the wearable device including: an resilient central frame; and first and second frames respectively coupled to both sides of the central frame to form a loop of which one region is open with the central frame, wherein the central frame includes a hollow cavity or through hole formed therein, and the first and second frames are outwardly spread without deformation and thus the central frame is resiliently deformed and the open portion at the one region is expanded.

A separation wall may be formed in a center portion of the hollow cavity or the through hole, and the cavities or the through holes may be laterally symmetrical with respect to the separation wall.

According to still another aspect of the present disclosure, there is provided a wearable camera device having a loop shape of which a front end is open to be wearable on a user′ neck, the wearable camera device including: a central frame provided at a position opposite the open portion of the front end; first and second frames symmetrically coupled to both sides of the central frame to form a loop of which the front end is open with the central frame; and one or more camera modules. In the wearable camera device, since the central frame made of an resilient material is resiliently deformed and the first and second frames are outwardly spread, the open portion of the front end may be expanded to secure a space for wearing the wearable camera device. A hollow cavity may also be formed in the central frame.

The central frame may be formed in a T-shape, the hollow cavity may have three end portions of both side surfaces and a lower portion which are open, and a lower end of a center portion of the central frame may be connected to a battery connection tube. A plurality of power supply lines accommodated in the battery connection tube may be branched to both sides in the hollow cavity of the central frame to be guided to both side surfaces of the T-shape.

Further, a separation wall may be formed in the center portion of the hollow cavity, and a lower portion of the separation wall may be opened so that a connection tube coupling hole of the battery connection tube coupled to the lower portion of the central frame may communicate with the cavities on both sides of the separation wall.

### Advantageous Effects

The wearable camera device of the present invention has no risk of low-temperature burns even in a state of being worn on the body for a long time, has a waterproof effect of the camera module, and is convenient to manufacture and maintain.

The wearable device of the present invention provides an excellent image quality by stably holding a plurality of cameras when worn on the user's body with easy wearing on the neck or body. The wearable camera device in which the power supply line for power supply from a large-capacity battery can be easily assembled, and damage of the power supply line due to friction or bending can be prevented even after repeated use, and thus a lifespan of a product is improved.

In addition, the present invention provides wearable device of which user convenience and assembly are excellent.

The present invention provides a combining structure of a band fixing part which is easily assembled but not separated.

According to another embodiment of the present disclosure, the device has excellent wearability while the relative position between a plurality of cameras is stable. Therefore, product reliability and convenience are improved while maintaining the quality of 360° images.

### BRIEF DESCRIPTION OF THE DRAWINGS

FIG. 1 is a perspective view of a wearable camera device according to one embodiment of the present disclosure.

FIG. 2 is a perspective view illustrating a back of the wearable camera device according to one embodiment of the present disclosure in a state in which the wearable camera device is worn on a user's neck,

FIG. 3 is a view illustrating a front of the wearable camera device according to one embodiment of the present disclosure worn by a user.

FIG. 4 is an exploded perspective view of the wearable camera device according to one embodiment of the present disclosure.

FIG. 5 is a perspective view which illustrates components adjacent to the central frame of the wearable camera device according to one embodiment of the present disclosure.

FIG. 6 is a perspective view illustrating a horizontal cross-sectional view of components adjacent to the central frame of the wearable camera device according to one embodiment of the present disclosure.

FIG. 7 is a vertical cross-sectional view of a center portion of the central frame of the wearable camera device according to one embodiment of the present disclosure.

FIG. 8 is an exploded perspective view of a camera holder and a camera module according to another embodiment of the present disclosure.

FIG. 9 is a perspective view illustrating a cut surface of a lower cover of the camera holder of the present disclosure.

FIG. 10 is a view illustrating a cut surface of the lower cover of the camera holder and hook coupling parts of a band fixing part of the present disclosure.

FIG. 11 is a view illustrating coupling parts of the lower cover and the upper cover of the camera holder according to one embodiment of the present disclosure.

FIG. 12 is a view illustrating a thermal image and a temperature distribution when a high-resolution camera of the wearable camera device of the present disclosure is operated.

### DETAILED DESCRIPTION OF EXEMPLARY EMBODIMENTS

Preferable embodiments of the present disclosure will be described with reference to the drawings to sufficiently understand the present disclosure. The embodiments of the present disclosure may be modified into various forms, and the scope of the present disclosure should not be understood as being limited to embodiments which will be described in detail below. Shapes of elements and the like in the drawings may be shown to be exaggerated for clearer descriptions. In the specification, “coupling” or “connection” means not only a case in which two components are directly coupled or connected to each other but also a case in which two components are indirectly coupled or connected to each other with another component. Further, detailed descriptions of known functions and configurations which may unnecessarily obscure the principle of the present disclosure will be omitted.

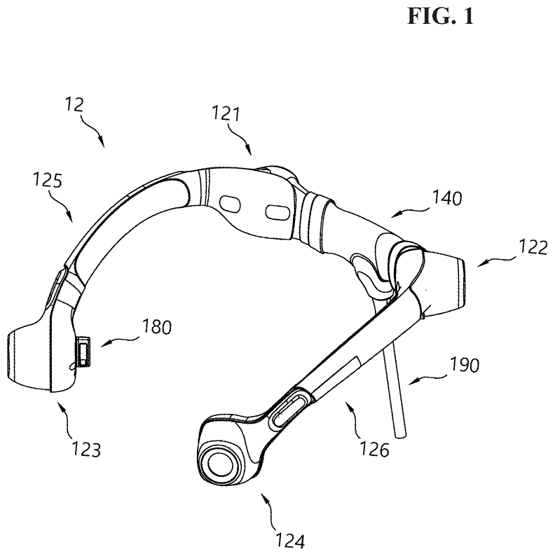

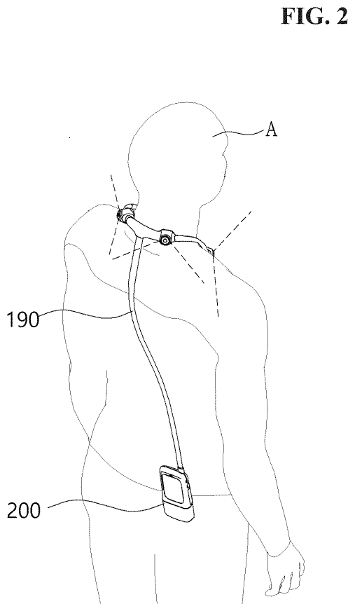

Hereinafter, the preferable embodiments of the present disclosure will be described with reference to FIGS. 1 to 11. FIG. 1 is a perspective view mainly illustrating a portion of a wearable camera device according to one embodiment of the present disclosure mounted on a neck, and FIG. 2 is a perspective view illustrating a back of the wearable camera device according to one embodiment of the present disclosure in a state in which the wearable camera device is worn on the user's neck.

Referring to FIGS. 1 and 2, the wearable camera device according to one embodiment of the present disclosure includes a frame part 12 equipped with a plurality of camera holders 121, 122, 123, and 124 which are spaced apart from each other, a plurality of camera modules respectively coupled to the plurality of camera holders 121, 122, 123, and 124 to image different directions around a user to generate image data, a battery 200 provided to be spaced apart from the frame part 12, and a battery connection tube 190 which connects the battery 200 and the frame part 12. The battery connection tube 190 accommodates a plurality of camera power supply lines (not shown) which supply power from the battery to the plurality of camera modules to guide the plurality of camera power supply lines to the frame part 12. Although the camera power supply lines are not explicitly shown in the drawings of the specification, those skilled in the art may sufficiently understand the disposition of the plurality of camera power supply lines accommodated or embedded in the battery connection tube 190 and the frame part 12 to supply power to the plurality of camera modules from the drawings and the detailed descriptions.

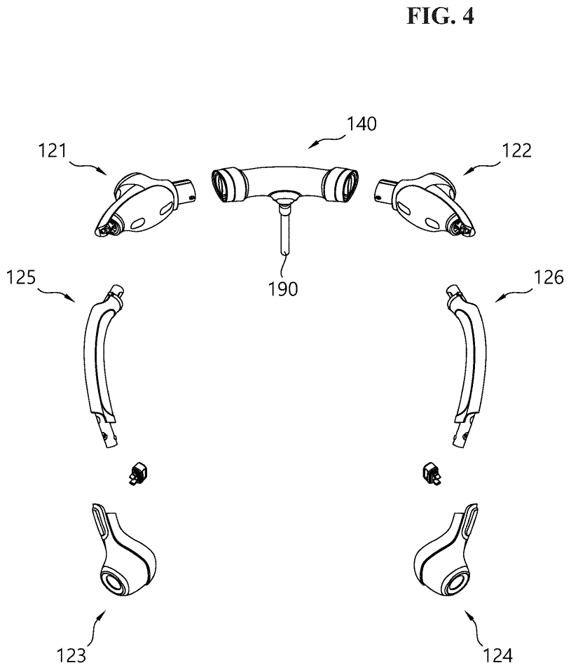

The frame part 12 detachably mounted on a user's body, specifically, the user's neck, includes an resilient central frame 140, and a first frame 125 and a second frame 126 symmetrically coupled to both sides of the central frame. According to the embodiment in FIG. 4, the frame part 12 has a loop shape of which one region (a front end) is open, and the central frame 140 is provided at a position opposite the open portion at the front end, and forms a loop having the open front end with the first and second frames.

The central frame 140 disposed at a center of the loop opposite the open portion is formed of an resilient material, for example, rubber (for example, a thermoplastic elastomer (TPE), and preferably, thermoplastic polyurethane (TPU)) or silicone which is flexible and thus may be deformed by applying a force when necessary while maintaining a shape thereof. The first and second frames 125 and 126 may be coupled to the camera holders 121, 122, 123 and 124 which accommodate the camera modules, or may be integrally formed with the camera holders. The first and second frames 125 and 126 are formed of a material having less resilience than the central frame or very low elasticity. This is to ensure that the shapes of the first and second frames are relatively firmly maintained in order to stably and firmly maintain positions of the camera modules coupled to the camera holders while the wearable camera device is worn.

The central frame 140 may be a resilient T-shaped tube of which the inside is hollow. In other words, the central frame 140 is composed of a T-shaped resilient member having a hollow cavity with three open ends, both side ends are connected to the first and second frames provided with the camera holders, and a lower end of a center portion is connected to the battery connection tube 190. The T-shaped hollow cavity of the central frame 140 accommodates a plurality of power supply lines which supply power to the plurality of camera modules from the battery connection tube thereunder, and provides additional flexibility to the resilient central frame.

Spaces which accommodate the camera modules and the power supply lines are respectively formed in the camera holders 121, 122, 123, and 124, and spaces which accommodate the power supply lines are also formed in the first and second frames 125 and 126. Each of the first and second frames 125 and 126 may have a hollow tube shape. Both side ends of the T-shaped cavity are open to be connected to tubes which accommodate the power supply lines of the first and second frames. The plurality of power supply lines (not shown) introduced from the battery connection tube 190 thereunder should be assembled to branch from the center portion of the T-shaped central frame, so that some power supply lines pass through the camera holder 121 at a left side to be guided to the first frame 125, and the remaining power supply lines pass through the camera holder 122 at a right side to be guided to the second frame 126. The hollow cavity formed in the central frame facilitates this assembly, and adds flexibility to the central frame to facilitate resilient deformation of the central frame when the wearable camera device is worn, and reduces wear or damage from the deformation of the central frame due to repeated use to increase a lifespan of the product.

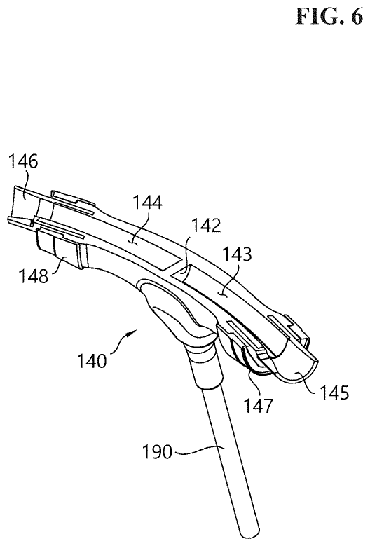

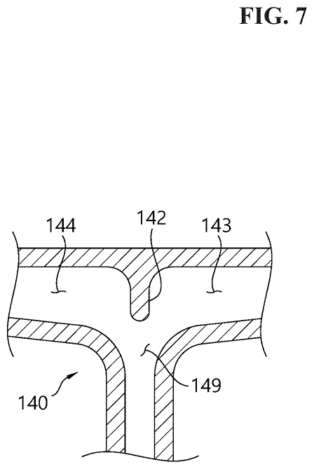

In a description of another embodiment of the present disclosure with reference to FIGS. 6 and 7, a separation wall 142 extending downward from an inner side surface of the central frame is formed in the center portion of the T-shaped cavity (or the inside of the central frame in the shape of the T-shaped tube) of the T-shaped central frame. The separation wall is integrally formed with the central frame 140 and is disposed in the center of the central frame. Due to the separation wall 142, the hollow cavity is divided into a left-side cavity 144 and a right-side cavity 143, and the cavities form a laterally symmetric structure with respect to the separation wall. Meanwhile, a portion connected to the connection tube coupling hole of the battery connection tube 190 under the separation wall is open, and the left-side cavity 144 and the right-side cavity 143 are connected to each other by a lower cavity 149.

When a wearable camera device having a structure without the separation wall is repeatedly used, since bending deformation is concentrated in the center portion of the T-shaped central frame or in one specific region, damage may occur due to friction or bending in the power supply lines accommodated in the central frame, and thus product malfunction may occur. When the separation wall is disposed in the center portion of the central frame, a portion to be flexible may be uniformly distributed left and right, and the bending deformation may be dispersed to the left- and right-side cavities 143 and 144 to prevent damage. That is, the central frame formed of a rubber material with the cavity for power supply lines increases bending rigidity in the center by the separation wall formed in the center, and the position where the deformation occurs is symmetrically dispersed. Simultaneously, the separation wall serves to guide the plurality of power supply lines accommodated in the battery connection tube 190 thereunder so that the plurality of power supply lines laterally branch at the time of assembly, and accordingly, assembly convenience is further enhanced.

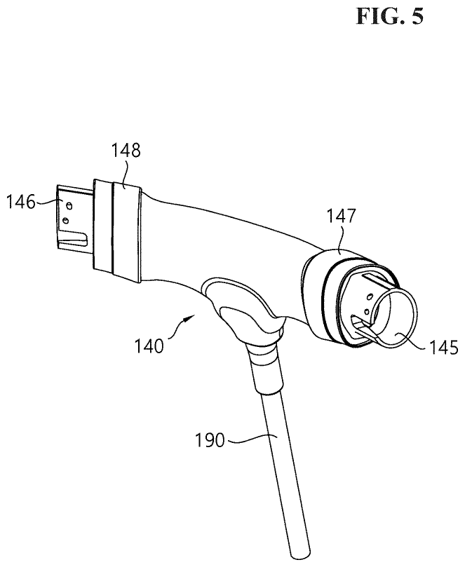

In a description of one embodiment of the present disclosure with reference to FIGS. 4 and 5, a first camera holder 121 is coupled between one end of the central frame 140 and one end of the first frame, and a second camera holder 122 is coupled between the other end of the central frame 140 and one end of the second frame. A third camera holder 123 is coupled to the other end of the first frame 125, and a fourth camera holder 124 is coupled to the other end of the second frame 126. The coupling may be enabled by a fastening means such as a screw or the like, but is not limited thereto, and various coupling means may be used. As shown in FIG. 4, the central frame 140 is disposed at a rear center of the loop-shaped frame part 12, and the camera holders 121 and 122 at both sides thereof are disposed at a rear of the loop to enable rear capturing. In this case, a transverse length of the central frame 140 is 20% or less, and preferably less than 15% of a loop length of the frame part 12 (a total length of a closed loop including an extending line of the frame part). Although the central frame formed of a resilient material is short whereas the first and second frames including the camera holders are formed of a material having almost no deformation, the central frame with the cavity may be flexibly deformed and simultaneously maintain a long lifespan.

The central frame 140, the first to fourth camera holders, and the first and second frames are formed with a hollow which accommodates and guides the power supply lines, and the central frame, the first to fourth camera holders, and the first and second frames are coupled to form the loop-shaped frame part with an open front, and have a laterally symmetric structure with respect to the center portion of the central frame 140. The third and fourth camera holders 123 and 124 are located at the front of the loop-shaped frame part of which one region is open, and are spaced apart from each other to form a front open portion therebetween.

Meanwhile, according to another embodiment of the present disclosure, some of the plurality of camera holders and the first and second frames may be integrally formed. For example, it may be possible that the first frame 125 is composed of two components of upper and lower casings which are coupled to each other, and the upper casing is integrally formed to extend to function as an upper cover of the first camera holder and/or the third camera holder, and the lower casing is integrally formed to function as a lower cover of the first camera holder and/or the third camera holder.

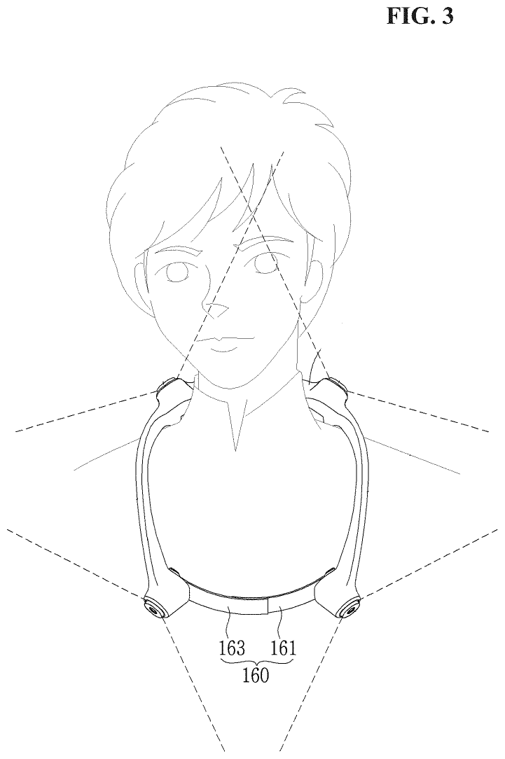

According to another embodiment of the present disclosure, the first and second frames of the frame part 12 may extend to come into contact with or overlap each other. That is, the frame part 12 may have an openable closed loop structure. Likewise, as shown in FIG. 3, the closed loop may be formed by providing a separate body fixing band part 160. In the case of a structure in which the first and second frames are coupled to each other, the frame part may be the closed loop but the first and second frames may be detachably coupled to each other by a magnet or another simple device to easily open the fastening part between the first and second frames for wearing. In this case, the camera holders 123 and 124 may not be present, or may be formed in a middle of the first and second frames, and a body fixing band formed of a rigid material may be coupled to the camera holders so that the first and second frames may extend.

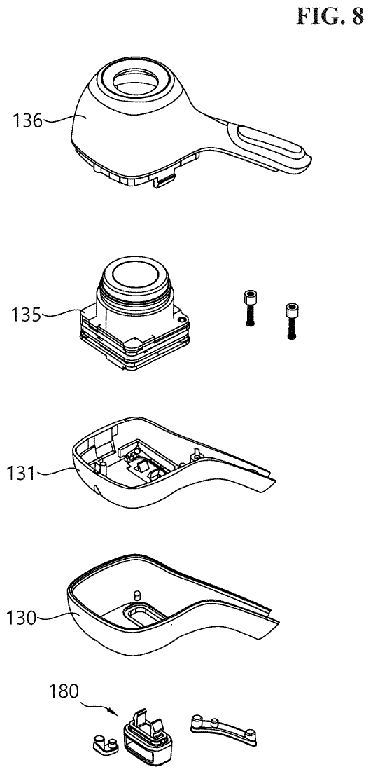

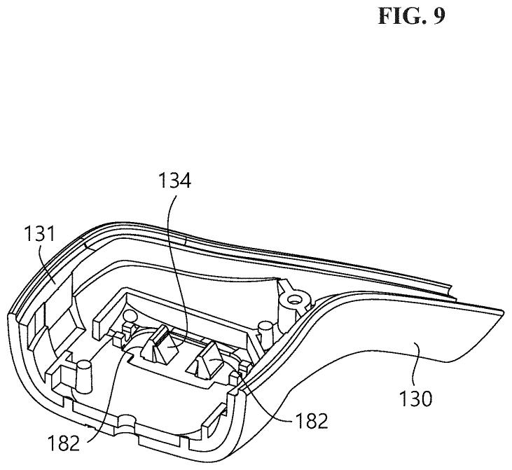

Configuration of the camera holders is described in detail with reference to FIGS. 8 to 10. FIG. 8 is an exploded perspective view of one of the third and fourth camera holders 123 and 124 in which the camera module is accommodated, and FIG. 9 is a cut view of the lower cover of the camera holder in a longitudinal direction.

A camera module 135 includes an optical system and an imaging device, and is accommodated and fixed in the camera holder, and the camera holder includes an upper cover 136 and lower covers 130 and 131 each having an approximately box shape. The upper cover 136 formed with an opening in a center of an upper surface is coupled so that the opening is aligned with the optical system of the camera module 135. The lower covers 130 and 131 and the upper cover 136 are coupled to form a case-shaped camera holder to accommodate the camera module 135 therein.

The lower cover includes a base portion 131 and a cover portion 130 under the base portion, and the base portion 131 has a structure corresponding to the upper cover 136 to be coupled to the upper cover 136. For example, in the base portion 131 and the upper cover 136, screw holes for fastening by screws are respectively formed at corresponding positions, and shapes of corners where the upper cover and the base portion come into contact correspond to each other. An upper surface of the cover portion 130 may have a shape corresponding to a lower surface of the base portion 131 to be tightly coupled to the base portion 131, or may be integrally formed with the base.

Meanwhile, a wearing position of the wearable camera device of the present disclosure is around the neck, and there is a concern about low-temperature burns when the camera holder which accommodates the high-resolution camera module touches the body (neck) for a long time. According to the internationally accepted safety standard EN563, a burn surface temperature limit of plastic is specified to be 48 degrees within 10 minutes, and 43 degrees within 8 hours. When the high-resolution camera module accommodated in the plastic camera holder was operated, heat generated from the camera module accommodated in the narrow camera holder was directly transferred to the camera holder, and each of the temperatures of the surfaces of the upper and lower covers was confirmed to be 42 degrees to 48 degrees or higher. Specifically, since the lower cover is a portion which is adjacent to the imaging device of the camera module, and at the same time, an outer surface of the lower cover is a portion which comes into contact with a wearer's neck, heat generated from the imaging device is transferred through the surface of the lower cover and thus easily causes low-temperature burns on the wearer's neck.

The lower cover of the camera holder according to one embodiment of the present disclosure is formed of a rubber material, preferably, a thermoplastic elastomer (TPE), and more preferably, thermoplastic polyurethane (TPU), rather than plastic and thus has an insulating effect to reduce heat transferred from the camera module to the body (neck). In this case, a temperature difference between the camera module and the rubber cover may be approximately 10 degrees or more.

Hereinafter, the camera holder including the lower cover according to still another embodiment of the present disclosure will be described with reference to FIGS. 8 and 9. The base portion 131 of the lower cover is formed of a plastic material, for example, polycarbonate, and the cover portion 130 integrally formed with the lower surface of the base portion 131 is formed of a rubber material, specifically, TPE, and more preferably, a TPU material.

The lower cover may be preferably molded by double injection. The base portion 131 formed of plastic, for example, a polycarbonate material, and the cover portion 130 formed of a rubber material, specifically, a TPU material, are integrally molded by double injection. First, after the base portion 131 is molded, the cover portion is molded in close contact with a lower portion of the base portion 130. Accordingly, a structure of the camera holder, in which an assembly process is simple, the insulating effect is excellent, and the size is compact, may be maintained.

In order to increase the reliability of the lower cover and to solidify an integration effect, it is possible to increase a contact effect through hole contact as well as surface contact between the polycarbonate and the rubber. That is, a coupling force may be increased by forming a hole in a bottom surface of the base portion 131 and inserting rubber into the hole when the rubber cover portion 130 is injected. For convenience of description, the third and fourth camera holders have been described as examples, but the same lower cover configuration may be used for the first and second camera holders. Although specific shapes may be partially different, it is the same that a double-structure lower cover in which basic plastic/rubber materials are integrally coupled is provided.

In a detailed description of a structure of the coupling parts between the upper cover 136 and the lower covers of the camera holder, two hook portions are formed opposite to each other at a lower end of the upper cover, and are engaged with jaws of the base portion of the lower cover to be hook-coupled to the base portion of the lower cover. The upper cover and the camera modules are fixed by hook-coupling with the lower covers after accommodating the camera modules in the upper cover.

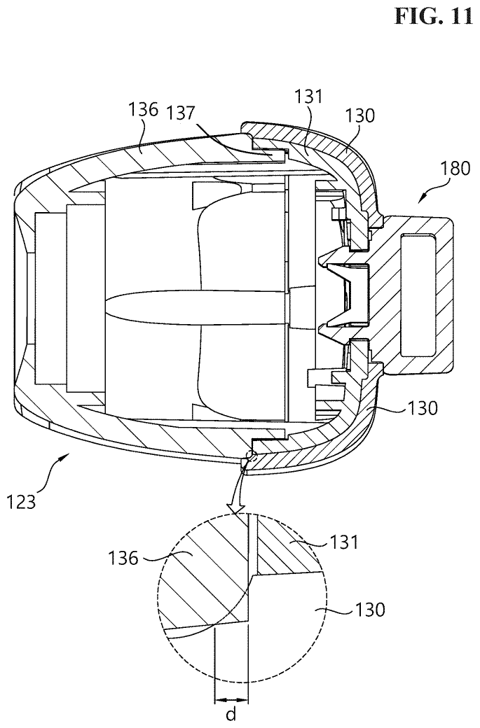

In a detailed description of a bonding structure between the upper cover and the lower covers with reference to FIG. 11, a lower protruding part 137 protruding downward is formed along an inner circumference on a lower surface of the upper cover 136, and the lower protruding part is accommodated in an accommodation step part formed on an upper surface along an inner circumference of the base portion of the lower cover. An upper end of the rubber cover portion 130, which is tightly coupled to the outer surface of the box-shaped base portion 131 formed of a polycarbonate material by double injection, is formed to protrude more than an upper end of the base portion, and thus the upper end of the base portion and the upper end of the cover portion form a step. An upper inner circumferential surface of the cover portion 130 forming the step is rounded, and this round portion is formed to be concave along the inner circumferential surface from the upper end of the cover portion to extend to the upper surface of the base portion 131. A lower outer circumferential edge of the upper cover 136 formed of a plastic material such as polycarbonate comes into close contact with the round portion and is tightly coupled while pressurizing the round portion of the cover portion formed of a rubber material (TPE), and thus a waterproofing effect is imparted to the coupling parts between the upper cover and the lower covers.

Generally, in the case of electronic goods, tolerance for assembling the upper and lower covers formed of polycarbonate or acrylonitrile butadiene styrene (ABS) is designed to be 0.05 mm to 0.1 mm, considering that there is deformation during mold cooling of the electronic goods. However, in this case, since moisture penetration due to the assembly tolerance is difficult to be prevented, a separate waterproofing treatment is required. However, according to one embodiment of the present disclosure, since a material of the cover portion 130 of the lower cover is an resilient material as a rubber material such as TPE, assembly may be performed even when a lower edge of the upper cover 136 and the round portion of an upper inner circumferential surface of the cover portion 130 are designed to overlap each other with a depth d of 0.1 to 0.2 mm Overlap may be absorbed and accommodated by the deformation of the cover portion, which is an resilient material, and watertightness is secured without the separate waterproof treatment.

Further, regarding the lower cover, the base portion and the cover portion at a lower surface may be molded by double injection, but other methods, for example, various methods such as a method of forming a rubber cover portion using a three-dimensional (3D) printer on the lower surface of the injection-molded base portion may be considered.

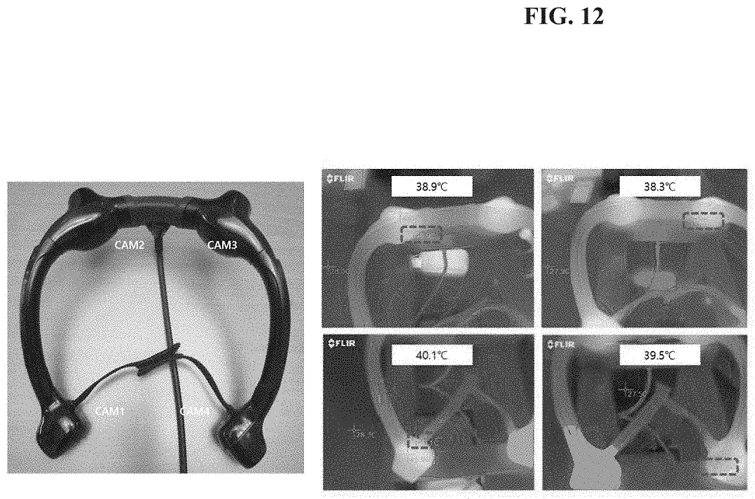

FIG. 12 briefly illustrates a thermal image in a state in which a wearable camera device which adopts a double-injection polycarbonate (PC)/TPU combination lower cover according to the embodiment of the present disclosure is operated and a temperature distribution in the camera holder. The upper cover is composed of plastic, and it can be seen that the temperature of a portion corresponding to the upper cover is 8 degrees higher than that of the polycarbonate/TPU combination lower cover are combined. It can be seen that the surface of the lower cover adjacent to the imaging device, which is the main heating source, is lower than the upper cover surface and safety standards are met.

Meanwhile, a body fixing band 160 may be provided in a front opening portion of the frame part 12. As shown in FIG. 3, the body fixing band 160 includes a first band 161 and a second band 163 respectively coupled to both lateral ends of the frame part. As shown in FIG. 3, the body fixing band 160 more firmly fixes the frame part 12 to the user's neck when the wearable camera device is worn on the user's neck. Accordingly, the frame part 12 may be prevented from excessively moving during a user's physical activity, and clearer image data may be obtained. The first band 161 and the second band 163 may be respectively provided with male and female Velcro, and end portions thereof may be coupled to each other. However, the body fixing band is not limited to Velcro, and rigid materials as well as materials such as a string and the like may be adopted.

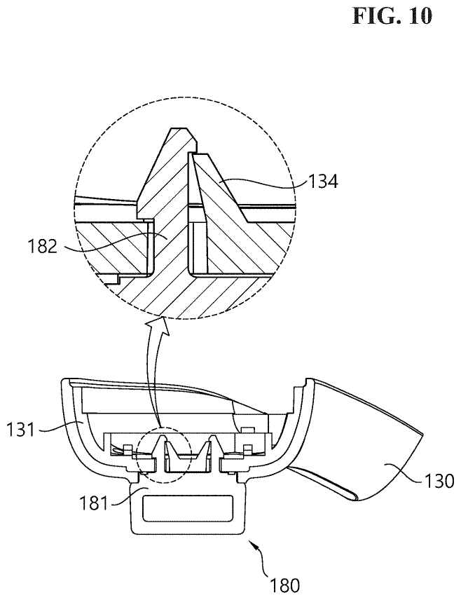

A band fixing part 180 which fixes the body fixing band 160 to the frame part will be described in detail with reference to FIGS. 9 and 10. The band fixing part 180 is coupled to the camera holders 123 and 124 disposed at a front of the frame part, and includes a base 181, a hook part formed on the base 181 to protrude, and a ring part formed under the base portion. The ring part is provided so that the body fixing band is inserted and coupled, and the band fixing part 180 is coupled to the lower covers of the camera holders 123 and 124 by hook-fastening.

Referring to FIGS. 9 and 10, the hook part 182 of the band fixing part 180 has a quadrangular pillar shape protruding upward from the base 181, and is inserted into a through hole formed in the lower cover, and the protruding parts formed on both sides of the hook part are respectively engaged with a base portion bottom surface and an inclined protrusion of the lower cover to be fixed.

The hook part has a quadrangular pillar shape protruding from the planar base 181 and elongated in a longitudinal direction, wherein a first protruding part having a first inclined surface protruding outward from the upper end is disposed on one side surface (a first side), and a second protruding part having a second inclined surface or a curved surface protruding outward from the upper end portion of the hook part is formed on the other side opposite the first side. A lower surface of the first protruding part in which the first inclined surface is formed at the outside extends to an inner side of the pillar, and a distance between the lower surface of the first protruding part and the base is a value of the sum of a tolerance and a thickness of the lower cover.

Meanwhile, the through hole into which the hook part is inserted is formed in the lower cover to correspond to a lower shape of the hook part. An inclined protrusion 134 which supports the lower surface of the second protruding part from below is formed in a region of the lower cover adjacent to the through hole. The inclined protrusion 134 is formed to extend at one side of the through hole toward an upper portion of the through hole, and has an inclination angle of 165° to 175°, and preferably, 170° with respect to the side surface of the through hole. According to this configuration, when the hook part is inserted through the through hole, the second protruding part is inserted while pushing the protrusion outward, and the upper end portion of the protrusion supports and fixes the lower surface of the second protruding part from below due to elasticity. Locking by a general hook has a disadvantage of being separable by applying a very large force, but since the double hook locking manner according to the embodiment of the present disclosure has a structure which is easy to be assembled, but may be internally disassembled only by a professional manager, it is a fastening structure which has good assembly and is solid.

Meanwhile, configurations related to the frame part of the present disclosure may be applied to various wearable devices which are wearable on an approximately cylindrical body part such as a user's neck, wrist, or waist, as well as a wearable camera device having a loop shape with one open region.

In the above, although the present disclosure is described with reference to the preferable embodiments of the present disclosure, it may be understood that those skilled in the art may variously change and modify the present disclosure without departing from the spirit and the region of the present disclosure disclosed in the following claims.

1. A wearable camera device, which can be removably worn around a user's neck, comprising:
a central frame;
a first and a second frames respectively coupled to both sides of the central frame to form a frame part, which is loop-shaped, together with the central frame; and
one or more camera modules provided on the frame part,
wherein the first and second frames are configured to be outwardly spread and thus the central frame made of a resilient material is configured to be resiliently deformed to generate or expand an open portion on one end of the frame part, thereby providing a space for the user to wear the wearable camera device.

2. The wearable camera device of claim 1, wherein a hollow cavity is formed in the central frame and the frame part is a partially open loop or a closed loop.

3. The wearable camera device of claim 2, wherein the central frame is formed in a T-shape, and the hollow cavity has three end portion of both sides and a lower portion which are open,
wherein a lower end of the central frame is coupled with a battery connection tube, a plurality of power cables accommodated in the battery connection tube being branched to both sides in the cavity of the central frame to be guided toward both sides of the T-shape.

4. The wearable camera device of claim 2, wherein a separation wall is formed in a central portion of the hollow cavity; a lower portion below the separation wall is open such that a connection tube coupling hole of the battery connection tube which is coupled to the bottom portion of the central frame is in communication with the hollow cavity on two sides of the separation wall.

5. The wearable camera device of claim 1, wherein a hollow cavity is formed in the central frame and a separation wall is formed at a central portion of the hollow cavity, such that the hollow cavity is formed in symmetrical arrangement with the separation wall as a center.

6. The wearable camera device of claim 1, wherein each of the one or more camera modules is accommodated in a camera holder, and the camera holder includes a cover part formed of a rubber material integrally formed on an outer surface of a base part formed of plastic.

7. The wearable camera device of claim 1,
wherein each of the one or more camera modules is accommodated in a camera holder, and the camera holder includes an upper cover and a lower cover coupled to the upper cover,
wherein the upper cover is disposed on an image capturing direction of the camera module, with an opening formed on a top of the upper cover, and covers an upper portion of the camera module, wherein the lower cover is arranged on a lower portion of the camera module and is adjacent to the user's body when wearing by the user, and
wherein the lower cover comprises a cover portion coupled to the base portion, and the base portion formed of plastic and the cover portion formed of TPE are integrally formed through a double injection molding.

8. The wearable camera device of claim 7, wherein an upper end of the cover portion protrudes further outwardly than an upper end of the base portion, such that the upper end of the base portion and the upper end of the cover portion form a stage; an inner periphery of the upper end of the cover portion is formed in a round portion, and an outer circumferential edge of a lower end portion of the upper cover is fitted with the round portion, so as to push the round portion to achieve a fitting combination.

9. A wearable device, which is configured to be worn wore on a body of a user, the wearable device comprising:
a central frame formed of a resilient material; and
a first frame and a second frame respectively coupled to both sides of the central frame to form a loop of which one region is open together with the central frame;
wherein a hollow cavity or a through hole is formed in the central frame;
wherein the first frame and the second frame are configured to be outwardly spread without deformation and the central frame made of a resilient material is configured to be resiliently deformed, thereby providing an open portion at the one region being expanded.

10. The wearable device of claim 9, wherein a separation wall is formed on a central portion of the hollow cavity or the through hole, such that the hollow cavity or the through hole is formed in symmetrical arrangement with the separation wall as a center.
